(19) United States
(12) Patent Application Publication
(10) Pub. No.: US 2018/0170764 A1
(43) Pub. Date: Jun. 21, 2018

(54) PROCESS FOR PREPARING SMALL SIZE LAYERED DOUBLE HYDROXIDE PARTICLES

(71) Applicant: SCG Chemicals Co., Ltd., Bangkok (TH)

(72) Inventors: Dermot O'Hare, Oxford (GB); Miaosen Yang, Oxford (GB)

(21) Appl. No.: 15/551,643

(22) PCT Filed: Feb. 19, 2016
(86) PCT No.: PCT/GB2016/050420

§ 371 Date: Aug. 17, 2017

(30) Foreign Application Priority Data
Feb. 19, 2015 (GB) 1502832.7

(51) Int. Cl. C01F 7/66; C01F 7/16; B01D 9/00

(52) U.S. Cl. CPC C01F 7/66; C01F 7/164; C01F 7/162; B01D 9/0063; C01P 2004/64; C01P 2002/60; C01P 2004/22; C01P 2004/61; C01P 2004/62; C01P 2002/22

(57) ABSTRACT

A process for preparing particles of a layered double hydroxide of the general formula

[Mₚ^{z+}M′_{q}^{y+}(OH)₂]^{a+}(Xⁿ⁻)_{a/n}.bH₂O (I)

wherein M^{z+} and M′^{y+} are metal cations or mixtures of metal cations, z=1 or 2; y=3 or 4; p+q=1; b=0 to 10, Xⁿ⁻ is an anion, n is 1 to 5 and a is determined by p, q, y and z such that a=zp+yq−2, comprises
(a) mixing, in aqueous solution, M^{z+} cations, M′^{y+} cations and Xⁿ⁻ anions, with a base; and
(b) allowing the layered double hydroxide of formula (I) to precipitate from the solution mixed in step (a).

Preferably, M is Li, Mg, Zn, Fe, Ni, Co, Cu, Ca, or a mixture of two or more. Preferably, y is 3, and M′ is Al, Ga, In, Fe or a mixture of two or more thereof. Also provided are particles obtainable by the process, especially wherein M is Ca, M′ is Al, and Xⁿ⁻ is NO₃⁻. Particles of a layered double hydroxide wherein the particles have a particle size of not greater than 2000 nm, preferably not greater than 300 nm and especially not greater than 100 nm, are also provided. The layered double hydroxides according to the invention are useful in certain applications, for example, as adsorbents, coatings and catalyst supports.

The present invention relates to a process for preparing very small size particles of layered double hydroxides (LDHs).

Layered double hydroxides (LDHs) are a class of compounds which comprise two metal cations and have a layered structure. A review of LDHs is provided in Structure and Bonding; Vol 119, 2005 Layered Double Hydroxides ed. X Duan and D. G. Evans. The hydrotalcites, perhaps the most well-known examples of LDHs, have been studied for many years. LDHs can intercalate anions between the layers of the structure. WO 99/24139 discloses use of LDHs to separate anions including aromatic and aliphatic anions.

Owing to the relatively high surface charge and hydrophilic properties of LDHs, the particles or crystallites of conventionally synthesised LDHs are generally highly aggregated. The result of this is that, when produced, LDHs aggregate to form “stone-like”, non-porous bodies with large particle sizes of up to several hundred microns and low specific surface area of generally 5 to 15 m²/g (as disclosed for example in Wang et al Catal. Today 2011, 164, 198). Reports by e.g. Adachi-Pagano et al (Chem. Commun. 2000, 91) of relatively high surface area LDHs have specific surface areas no higher than 5 to 120 m²/g.

For use in certain applications (for example, adsorbents, coatings and catalyst supports), it is advantageous to provide LDHs of very small size.

It has previously been suggested that small particle LDHs can be obtained using, as solvent, a mixture of water and one or more organic solvent. Generally, such processes require ageing the mother liquor for a few hours at an elevated temperature, e.g. 50-200° C. to provide the required LDH particles. The use of organic solvents increases costs and introduces the need for solvent recovery procedures. Ageing at elevated temperatures not only increases production costs but also lengthens the production time required for obtaining the LDH particles.

It is an object of the present invention to provide a process for preparing small size LDH particles which overcomes disadvantages mentioned above, particularly one which does not require the use of organic solvents, elevated temperatures or essential ageing and/or drying steps.

When the LDH being produced is a Ca—Al LDH, it is often the case in prior art processes that the obtained product contains CaCO₃ as an impurity. It is, therefore, a further object of the present invention to provide a process which can produce Ca—Al LDH which is not contaminated by CaCO₃.

In particular, it is an object of the present invention to provide a process for preparing very small size LDHs, especially Ca—Al LDHs, which is quick, efficient and can be conducted with low costs.

According to a first aspect of the present invention, there is provided a Ca—Al—NO₃ layered double hydroxide, in a substantially pure form, and having a particle size of not greater than 2000 nm.

According to a further aspect of the present invention, there is provided a process for preparing particles of a layered double hydroxide of the general formula

[Mₚ^{z+}M′_{q}^{y+}(OH)₂]^{a+}(Xⁿ⁻)_{a/n}.bH₂O (I)

wherein M^{z+} and M′^{q+} are metal cations or mixtures of metal cations, z=1 or 2; y=3 or 4; p+q=1; b=0 to 10, Xⁿ⁻ is an anion, n is 1 to 5 and a is determined by p, q, y and z such that a=zp+yq−2
which method comprises
(a) mixing M^{z+} cations, M′^{y+} cations and Xⁿ⁻ anions, with a base; and
(b) allowing the layered double hydroxide of formula I to precipitate from the solution mixed in step (a),
   wherein step (a) is performed in aqueous solution, and under an atmosphere of air, for a period not longer than 15 minutes, and wherein the mixing speed and duration of step (a) are such that the layered double hydroxide that precipitates in step (b) has a particle size of not greater than 2000 nm.

According to a further aspect of the present invention, there is provided a layered double hydroxide of the general formula

[Mₚ^{z+}M′_{q}^{y+}(OH)₂]^{a+}(Xⁿ⁻)_{a/n}.bH₂O (I)

wherein M^{z+} and M′^{y+} are metal cations or mixtures of metal cations, z=1 or 2; y=3 or 4; p+q=1; b=0 to 10, Xⁿ⁻ is an anion, n is 1 to 5 and a is determined by p, q, y and z such that a=zp+yq−2, the layered double hydroxide being obtainable, obtained or directly obtained by a process defined herein.

When compared with prior art techniques, the present process provides numerous advantages. Chiefly, the present process provides a rapid method for producing small particle size LDH, the rapid nature of which being such that the method can be conducted under an atmosphere of air without detriment to the purity of the product. Accordingly, the present process obviates the need for an inert (e.g N₂) blanket, which has until now been necessary to avoid generating unwanted side products, such as calcium carbonate.

According to the process of the invention, step (a) comprises rapidly mixing M^{z+} cations, M′^{y+} cations and Xⁿ⁻ anions, with a base. The aqueous solution may be prepared by mixing together, in any order, an aqueous solution containing at least one salt of metal M, an aqueous solution containing at least one salt of metal M′, an aqueous solution containing Xⁿ⁻ anions and a solution containing a base, for instance, NaOH. Alternatively, the anion Xⁿ⁻ may be present in the solution containing M^{z+} cations or in the solution containing M′^{y+} cations, or in both of these solutions, or in the basic solution. According to a preferred embodiment, a solution will comprise a salt of metal M with the anion X and a salt of metal M′ with the anion X. A solution containing the base, such as NaOH, may then be added to this. When all of the cations, anion X and base are in solution together, the solution is preferably mixed rapidly.

It is preferred that M is Li, Mg, Zn, Fe, Ni, Co, Cu, or Ca, or a mixture of two or more thereof.

Further preferred is that y is 3 and M′ is Al, Ga, In, or Fe or a mixture of two or more thereof. When M′ comprises a mixture, it is preferably a mixture of Al and Fe.

According to a preferred embodiment, M′ is Al.

According to another preferred embodiment, in the layered double hydroxide, M/M′ is selected from Zn/Al, Ni/Al, Mg/Al, and/or Ca/Al, preferably Ca/Al.

In a further embodiment, it is preferred that Xⁿ⁻ is an anion selected from halide, inorganic oxyanion, anionic surfactants, anionic chromophores, and/or anionic UV absorbers.

Most preferred, the inorganic oxyanion is a carbonate, bicarbonate, hydrogenphosphate, dihydrogenphosphate, nitrite, borate, nitrate, sulphate, sulphite or phosphate anion or a mixture of two or more thereof, preferably a nitrate anion.

According to one preferred embodiment, step (a) in the process of the invention is carried out in a high speed mixer and mixing is preferably carried out at a mixing speed not lower than 5000 rpm, more preferably not lower than 8000 rpm.

In another embodiment, step (a) in the process of the invention is carried out at a mixing speed not lower than 12,000 rpm. Suitably, step (a) in the process of the invention is carried out at a mixing speed not lower than 15,000 rpm. More suitably, step (a) in the process of the invention is carried out at a mixing speed not lower than 17,000 rpm. Such mixing speeds may, for example, be achievable by using a disperser or a homogeniser.

In a particular embodiment, step (a) in the process of the invention is carried out at a mixing speed of 18,500 rpm to 25,000 rpm (using, for example, a disperser or a homogeniser).

Mixing step (a) may be performed using a disperser or homogeniser having a rotor and a stator.

In another embodiment, the total volume of material mixed during step a) does not exceed 2 litres.

According to a different preferred embodiment, step (a) in the process of the invention is carried out in a colloid mill and mixing is preferably carried out at a mixing speed not lower than 300 rpm.

Typically, mixing in step (a) of the process of the invention is carried out for a period of from 1 to 15 minutes.

In an embodiment, step (a) is performed for a period not longer than 10 minutes. Suitably, step (a) is performed for a period not longer than 5 minutes.

In an embodiment, step (a) is performed for a period of between 0.5 and 5 minutes at a mixing speed not slower than 1500 rpm. Suitably, step (a) is performed for a period of between 0.5 and 3 minutes at a mixing speed not slower than 1500 rpm. More suitably, step (a) is performed for a period of between 0.5 and 5 minutes at a mixing speed not slower than 10,000 rpm. In a particular embodiment, step (a) is performed for a period of between 0.5 and 3 minutes at a mixing speed not slower than 17,500 rpm.

In an embodiment, the mixing speed and duration of step (a) are such that the layered double hydroxide that precipitates in step (b) has a particle size of not greater than 1000 nm, preferably not greater than 800 nm, more preferably not greater than 500 nm, more preferably not greater than 300 nm, and most preferably not greater than 100 nm.

According to an embodiment, the base comprises OH⁻ anions. Preferably, the base is NaOH.

Furthermore, it is preferred that the pH value of the aqueous solution is adjusted by the addition of NaOH or a mixture of NaOH and NaX (X=anion) to the solution.

Typically, in step (a) above, whether a high speed mixer or a colloid mill is used as the mixing apparatus for performing the rapid mixing, in aqueous solution of the M^{z+} cations, M′^{y+} cations and Xⁿ⁻ anions with a base, solutions containing the ions and base are preferably added to the mixing apparatus simultaneously. Mixing, in step (a), is preferably commenced within 30 min after the addition of all of the cations, anion Xⁿ⁻ and base, in aqueous solution, to the mixing apparatus and, most preferably, immediately.

A further object is achieved by a Ca—Al—NO₃ layered double hydroxide, in a substantially pure form, and having a particle size of not greater than 2000 nm, preferably not greater than 300 nm and most preferably not greater than 100 nm.

It has been found that a rapid mixing of the solution promotes rapid nucleation of the LDH. The rapid nucleation under rapid mixing conditions causes quick precipitation of the LDH but halts the growth of LDH crystals such that an LDH colloid is formed having very small particle size, typically not greater than 2000 nm, preferably not greater than 800 nm, more preferably not greater than 500 nm, even more preferably not greater than 300 nm, yet even more preferably not greater than 200 nm and, most preferably, not greater than 100 nm.

The particle size was determined as the mean platelet diameter from a study of 100 particles by Transmission Electron Microscopy (TEM).

Rapid precipitation also improves the purity of the LDHs, particularly in the case of the preparation of Ca-containing LDHs in air where CaCO₃ precipitation is a highly favoured side reaction.

According to a preferred embodiment of the process of the invention, an aqueous solution of a salt of metal(s) M with the anion X and an aqueous solution of a salt of metal(s) M′ with the anion X are added to a mixer. These may be added separately or a solution containing all of the ions may be prepared first and then added to the mixer together with a base.

The aqueous solutions of the metal salts prepared and added to the mixer in the process are substantially pure. By the term “substantially pure” it is meant that the aqueous solutions do not contain any deliberately or intentionally added substances or compounds, such as organic solvents or aqueous anions other than X. In addition, purity of the product may be enhanced by using de-ionised water in the preparation of the solution or degased de-ionised water.

In the context of Ca—Al—NO₃ LDHs, the term “substantially pure” also means that the LDH contains no calcium carbonate. This can be determined, for example, by XRD analysis, since the Ca—Al—NO₃ LDHs of the invention contain no other observable Bragg reflections from other crystalline contaminants, such as metal carbonates. In this sense, the Ca—Al—NO₃ LDHs of the invention are considered to be phase pure.

The metal salt aqueous precursor solutions typically have a high concentration of the metal salt. More typically, the concentration of the salt of metal M with the anion X in the aqueous solution will be in the range of 0.1 to 3 M, preferably 0.1 to 1.5 M. Alternatively, the concentration of the salt of metal M with the anion X in the aqueous solution will be in the range of 0.1 to 1 M, preferably 0.1 to 0.8 M, more preferably 0.1 to 0.7 M, yet more preferably 0.3 to 0.7 M. The concentration of the salt of metal M′ with the anion X in the aqueous solution will be chosen according to the requirement for M′ in the LDH and based on the concentration of the salt of metal M used. For instance, in the case where z in the formula I is 2 and y in the formula I is 3, the concentration of the M′ salt in its aqueous precursor solution will typically be about one half of the concentration of the M salt in its aqueous precursor solution so as to avoid the use of excess metal cations. Highly concentrated metal salt solutions promote rapid LDH precipitation under alkali conditions (pH>7) which further improves the phase purity of the LDHs, particularly in the case of the preparation of Ca-containing LDHs in air, where CaCO₃ precipitation is a highly favoured side reaction.

Preferably, a base such as NaOH is added to the metal ion solution, during mixing, in order to raise the pH of the solution to a pH value greater than 7, preferably greater than 9, more preferably greater than 10.

It has been found by the inventors that, surprisingly, under rapid mixing conditions, there is a relationship between the concentration of the M and M′ metal salt precursor solution used and the size of the LDH crystals obtained by the process of the invention. For instance, using a solution of 0.64 M Ca(NO₃)₂.4H₂O and 0.32 M Al(NO₃)₃.9H₂O and mixing this with 2.2 M NaOH for 90 s at a mixing speed of 20,000 rpm, LDH crystals of 100 nm are obtained whereas LDH crystals of 200-300 nm are obtained by mixing a solution of 0.32 M Ca(NO₃)₂.4H₂O and 0.16 M Al(NO₃)₃.9H₂O under the same mixing conditions. If, under the same conditions, a solution which is 0.16 M in Ca(NO₃)₂.4H₂O and 0.08 M in Al(NO₃)₃.9H₂O is subjected to rapid mixing then the LDH crystals obtained are in the size range of 400-500 nm.

Mixing apparatus which can be used to carry out the rapid mixing of the aqueous solution containing the metal cations, the anion Xⁿ⁻ and the base according to the present invention, may be any apparatus known to provide the required mixing speed. Examples of such apparatus known to the person skilled in the art of rapid mixing technology include high speed mixers, blenders and colloid mills.

After subjecting, in aqueous solution, M^{z+} cations, M′^{z+} cations, Xⁿ⁻ anions and base, to rapid mixing, in accordance with the process of the invention, the mixed solution may, if desired, be subjected to ageing. Ageing the mixture, if desired, may typically be carried out by maintaining the mixture in the mixer, reducing the mixing speed of the mixer and maintaining mixing at the lower speed for a period of time. Typically, the mixing speed of the mixer during an ageing step, if used, will be about 8000 rpm or, preferably, lower, e.g. 5000 rpm or lower. The ageing step, at a reduced mixer speed, may typically be carried out for at least 1 hour and preferably at least 2 hours. It is also possible, after this ageing step, to continue ageing at an even lower mixing speed, e.g. 600 rpm, for up to 24 hours. Since ageing the mother liquor has been found to increase the particle size of the LDH product and/or increase the size distribution of the LDH product, the use of ageing in the process of the invention is not preferred.

According to step (b) of the process of the invention, the layered double hydroxide is allowed to precipitate from the solution mixed in step (a). The precipitated material is, thus, obtained as an aqueous slurry or paste. In such a slurry or paste, the LDH particles obtained tend not to form aggregates. Removal of water in order to concentrate an aqueous slurry or paste may be achieved by centrifugation of the liquor containing the precipitated material. Typically, the liquor containing the LDH particles may be subjected to centrifuge at 9000 rpm for a few to several minutes, for example 10 minutes. The treatment in the centrifuge may be repeated one or more times washing with de-ionised water between each centrifugation. In general, recovery may also, or instead, be facilitated by filtration, in particular when rather big particles are prepared, such as by the use of a filter candle.

Following step b), the precipitated LDH may be washed one or more times with water. Such washing steps may be necessary to remove excess salts.

Following isolation of the LDH, the LDH may be contacted with acetone or ethanol. Suitably the LDH is contacted with acetone at a weight ratio of LDH to acetone of 1:5 to 1:15 (e.g. 1:10) for 1 minute to 5 hours (e.g. 1 hour).

The isolated LDH may, in some embodiments, be dispersed in a solvent (e.g. ethyl acetate). Such a step may be necessary when it is desirable to form an organic solvent dispersion of the LDH for use in, for example, coating applications.

Typically, the aqueous slurry/paste obtained, for instance from the centrifugation step, will have a dry solids content in the range of from 12 to 45% by weight. If desired, LDH particles may be recovered from the slurry/paste containing the LDH particles by subjecting the slurry or paste to a drying procedure, so as to produce a dry, particulate product. Preferably, if a dry LDH product is desired, the drying procedure used should be selected from those procedures that minimise the possibility that the LDH particles will form aggregates during drying. If drying the product is desired, preferably a drying procedure such as vacuum drying at low temperature (e.g. 20° C.) or spray drying should be used to minimise any aggregation of the particles.

The process of the invention may be used to prepare particles of an LDH of the formula I above. According to a preferred embodiment, the LDH has the formula I in which z is 2 and M is Mg, Zn, Fe, Ni, Co, Cu or Ca or a mixture of two or more of these, when z is 1, M is preferably Li. Preferably, M is Ca. According to another embodiment, the LDH has the formula I in which y is 3 and M′ is Al, Ga, In, or Fe or a mixture of Al and Fe. Preferably, M′ is Al. According to an embodiment, the LDH is selected from Zn/Al, Ni/Al, Mg/Al and Ca/Al LDHs. It is an especially preferred embodiment of the invention that the LDH is a Ca/Al LDH.

The anion X is an anion preferably selected from halide (for example, chloride), inorganic oxyanion, anionic surfactants, anionic chromophores, and/or anionic UV absorbers. Examples of inorganic oxyanions include carbonate, bicarbonate, hydrogenphosphate, dihydrogenphosphate, nitrite, borate, nitrate, sulphate, sulphite and phosphate and mixtures of two or more of these. According to a preferred embodiment, the anion X is nitrate.

According to a particularly preferred embodiment of the process of the invention, the LDH prepared is a CaAl—NO₃ LDH.

The present invention provides, according to a particularly preferred embodiment, a process for preparing particles of a Ca—Al—NO₃ LDH, which particles have a size of not greater than 2000 nm, preferably not greater than 300 nm and most preferably of not greater than 100 nm which process comprises
(a) adding an aqueous solution containing Ca(NO₃)₂.4H₂O and Al(NO₃)₂.9H₂O and a basic solution of NaOH to a high speed mixer;
(b) subjecting the solutions to mixing for 1 to 15 minutes at a mixing speed not lower than 5,000 rpm, preferably not lower than 8,000 rpm, such that a precipitate of Ca—Al—NO₃ LDH is produced;
(c) centrifuging the liquor containing the precipitated LDH at 5,000 to 25,000 rpm for 1-15 minutes, or filtrating by a filter candle; and
(d) optionally repeating step (c) one or more times.

The precipitated LDH produced according to this embodiment may, if desired, be recovered. Typically, recovery of the precipitated LDH will be achieved according to any of the various procedures described above.

According to an alternative embodiment, the present invention provides a process for preparing particles of a Ca—Al—NO₃ LDH, which particles have a size of not greater than 2000 nm, preferably not greater than 300 nm and most preferably of not greater than 100 nm which process comprises
(a) adding an aqueous solution containing Ca(NO₃)₂.4H₂O and Al(NO₃)₂.9H₂O and a basic solution of NaOH to a colloid mill;
(b) subjecting the solutions to mixing for 1 to 15 minutes at a mixing speed not lower than 300 rpm, such that a precipitate of Ca—Al—NO₃ LDH is produced;
(c) centrifuging the liquor containing the precipitated LDH at 5,000 to 25,000 rpm for 1-15 minutes, or filtrating by a filter candle;
(d) optionally repeating step (c) one or more times.

The precipitated LDH produced according to this embodiment may, if desired, be recovered. Typically, recovery of the precipitated LDH will be achieved according to any of the various procedures described above.

Preferably, the precursor aqueous metal solution consists essentially of Ca(NO₃)₂.4H₂O and Al(NO₃)₂.9H₂O in degased deionised water. Preferably, the precursor aqueous metal solution is greater than 0.1 M in Ca(NO₃)₂.4H₂O, more preferably greater than 0.3 M, even more preferably greater than 0.6 M and most preferably greater than 1.0 M. Preferably, the Al(NO₃)₂.9H₂O in the precursor aqueous metal solution has a concentration which is approximately half the concentration of Ca(NO₃)₂.4H₂O in the solution, more preferably half the concentration of Ca(NO₃)₂.4H₂O in the solution.

Preferably, the precursor aqueous metal solution is adjusted to a pH value greater than 7, more preferably greater than 9, and even more preferably greater than 10, during the rapid mixing operation. Typically, an addition of NaOH will be used to adjust the pH value of the solution.

The fine, particulate Ca—Al—NO₃ LDH obtained according to this embodiment has great purity and is typically in the form of an aqueous slurry or paste. The LDH may be recovered according to any of the procedures described above. The particle size of the Ca—Al—NO₃ LDH is sufficiently small that it finds use as an adsorbent, in coating compositions or as a catalyst support.

According to a further preferred embodiment, the invention provides a Ca—Al—NO₃ layered double hydroxide, in a substantially pure form, which has a particle size of not greater than 1000 nm, preferably not greater than 800 nm, more preferably not greater than 500 nm, even more preferably not greater than 300 nm, and most preferably not greater than 100 nm.

If necessary, the aqueous slurry or paste recovered can be subjected to a drying operation that minimises the formation of aggregates of the LDH. Examples of drying operations include drying in a vacuum oven at low temperature under vacuum and spray drying using a conventional spray drying apparatus.

The following numbered paragraphs describe particular embodiments of the invention:
1. A process for preparing particles of a layered double hydroxide of the general formula

[Mₚ^{z+}M′_{q}^{y+}(OH)₂]^{a+}(Xⁿ⁻)_{a/n}.bH₂O (I)
wherein M^{z+} and M′^{y+} are metal cations or mixtures of metal cations, z=1 or 2; y=3 or 4; p+q=1; b=0 to 10, Xⁿ⁻ is an anion, n is 1 to 5 and a is determined by p, q, y and z such that a=zp+yq−2
which method comprises
(a) mixing, in aqueous solution, M^{z+} cations, M′^{y+} cations and Xⁿ⁻ anions, with a base; and
(b) allowing the layered double hydroxide of formula I to precipitate from the solution mixed in step (a).
2. The process according to paragraph 1, wherein M is Li, Mg, Zn, Fe, Ni, Co, Cu, Ca, or a mixture of two or more thereof.
3. The process according to paragraph 1 or paragraph 2, wherein y is 3 and M′ is Al, Ga, In, Fe or a mixture of two or more thereof.
4. The process according to any of the preceding paragraphs, wherein M′ is Al.
5. The process according to any of the preceding paragraphs, wherein, in the layered double hydroxide, M/M′ is selected from Zn/Al, Ni/Al, Mg/Al, and/or Ca/Al.
6. The process according to paragraph 5, wherein the layered double hydroxide is a Ca/Al layered double hydroxide.
7. The process according to any one of the preceding paragraphs, wherein Xⁿ⁻ is an anion selected from halide, inorganic oxyanion, anionic surfactants, anionic chromophores, and/or anionic UV absorbers.
8. The process according to paragraphs 7, wherein the inorganic oxyanion is carbonate, bicarbonate, hydrogenphosphate, dihydrogenphosphate, nitrite, borate, nitrate, sulphate, sulphite or phosphate or a mixture of two or more thereof, preferably nitrate.
9. The process according to any one of paragraphs 1 to 8, wherein step (a) is carried out in a high speed mixer and mixing is carried out at a mixing speed not lower than 5000 rpm, preferably not lower than 8000 rpm.
10. The process according to any one of paragraphs 1 to 8, wherein step (a) is carried out in a colloid mill and mixing is carried out at a mixing speed not lower than 300 rpm.
11. The process according to any one of paragraphs 1 to 10, wherein mixing is carried out for a period of from 1 to 15 minutes.
12. The process according to any of the preceding paragraphs, wherein the particles have a size of not greater than 2000 nm, preferably not greater than 300 nm, most preferably not greater than 100 nm.
13. The process according to any of the preceding paragraphs, wherein the base is a compound comprising OH⁻ anions, preferably NaOH.
14. The process according to any of the preceding paragraphs which additionally comprises a step of recovering the precipitated layered double hydroxide.
15. The process according to paragraph 1, wherein the particles are Ca—Al—NO₃ layered double hydroxide, which particles have a size of not greater than 2000 nm, preferably not greater than 300 nm and most preferably of not greater than 100 nm which process comprises
   (a) adding an aqueous solution containing Ca(NO₃)₂.4H₂O and Al(NO₃)₂.9H₂O and an aqueous solution of NaOH to a high speed mixer;
   (b) subjecting the solution to mixing for 1 to 15 minutes at a mixing speed not lower than 5000 rpm, preferably not lower than 8000 rpm, such that a precipitate of Ca—Al—NO₃ layered double hydroxide is produced;
   (c) centrifuging the liquor containing the precipitated layered double hydroxide at 5000 to 25000 rpm for 1-15 minutes, or filtrating by a filter candle; and
   (d) optionally repeating step (c) one or more times.
16. The process according to paragraph 1, wherein the particles are Ca—Al—NO₃ layered double hydroxide, which particles have a size of not greater than 2000 nm, preferably not greater than 300 nm and most preferably of not greater than 100 nm which process comprises
   (a) adding an aqueous solution containing Ca(NO₃)₂.4H₂O and Al(NO₃)₂.9H₂O and an aqueous solution of NaOH to a colloid mill;
   (b) subjecting the solution to mixing for 1 to 15 minutes at a mixing speed not lower than 300 rpm, such that a precipitate of Ca—Al—NO₃ layered double hydroxide is produced;
   (c) centrifuging the liquor containing the precipitated layered double hydroxide at 5000 to 25000 rpm for 1-15 minutes, or filtrating by a filter candle; and
   (d) optionally repeating step (c) one or more times.
17. The process according to any of the preceding paragraphs, wherein the pH of the aqueous solution obtained by the mixing step is greater than 7, preferably greater than 9 and more preferably greater than 10.
18. The process according to paragraphs 17, wherein the pH value of the aqueous solution is adjusted by the addition of NaOH or a mixture of NaOH and NaX, where X⁻ is an anion, to the solution.
19. Particles of a layered double hydroxide having the formula I

[Mₚ^{z+}M′_{q}^{y+}(OH)₂]^{a+}(Xⁿ⁻)_{a/n}.bH₂O (I)

wherein M^{z+} and M′^{y+} are metal cations or mixtures of metal cations, z=1 or 2; y=3 or 4; p+q=1; b=0 to 10, X is an anion, n is 1 to 5 and a is determined by p, q, y and z such that a=zp+yq−2, obtainable according to the process of any one of paragraphs 1 to 18.
20. Particles of a layered double hydroxide according to paragraph 19, wherein M is Ca, M′ is Al and Xⁿ⁻ is NO₃⁻.
21. Particles of a layered double hydroxide, the particles having a particle size of not greater than 2000 nm, preferably not greater than 300 nm, most preferably not greater than 100 nm.
22. Ca—Al—NO₃ layered double hydroxide, in a substantially pure form, and having a particle size of not greater than 2000 nm, preferably not greater than 300 nm and most preferably not greater than 100 nm.

### EXAMPLES

### Materials and Methods

Powder X-Ray Diffraction (XRD).

Powder X-ray diffraction patterns were recorded on a PANalytical X'Pert Pro instrument using a Cu anode and K-alpha 1 λ=1.540598 and K-alpha 2 λ=1.544426 with a K-alpha 2/K-alpha 1 ratio of 0.5. The generator voltage was set to 40 kV and the tube current to 40 mA at 0.01° s⁻¹ from 3 to 70° with a slit size of 1°. Samples were ground in powder form and loaded onto stainless steel sample holders.

Thermogravimetric Analysis (TGA).

Thermogravimetric analysis was carried out using a Mettler Toledo TGA/DSC 1 System. Around 20 mg of the sample was heated in a crucible from 25 to 700° C. at a rate of 5° C. per minute, and then left to cool.

Dynamic Light Scattering (DLS).

A Malvern Zetasizer Nano ZS in the Begbroke Science Park was used to carry out the dynamic light scattering analysis. A small amount of the sample in paste form was fully dispersed in about 10 mL of dionised water using a sonicator for 5 minutes, this dispersion was then pipetted into a plastic cuvette to the suggested level and inserted into the instrument.

Transmission Electron Microscopy (TEM).

Transmission electron microscopy images were obtained using a JEOL 2100 microscope with an accelerating voltage of 200 kV to view the samples. A small amount of the LDH sample in paste form was dispersed in ethanol in a sonicator for about 3 minutes, and then cast onto copper grids coated with Formvar film.

Fourier Transform Infrared (FTIR) Spectroscopy.

FTIR spectra were recorded on a Nicolet iS5 Spectrometer equipped with the iD3 ATR (attenuated total reflection) accessory, measuring in the range of 400-4000 cm⁻¹ with 50 scans at 4 cm⁻¹ resolution.

Solid State Nuclear Magnetic Resonance (NMR) Spectroscopy.

²⁷Al DPMAS and ¹³C CPMAS Solid state NMR spectra were obtained at 104.2 and 100.5 MHz respectively (9.4 T) on a Bruker Avance IIIHD spectrometer. For ²⁷Al NMR spectroscopy, in order to obtain quantitative MAS spectra, a single pulse excitation was applied using a short pulse length (0.15 μs). 7000 scans were acquired with a 0.1 s delay and a MAS rate of 40 kHz using 1.9 mm O.D zirconia rotors. The ²⁷Al NMR spectroscopy chemical shift is referenced to an aqueous solution of Al(NO₃)₃. ¹³C CPMAS NMR spectra were measured using 4 mm O.D zirconia rotors and a MAS rate of 10 kHz using a cross-polarization sequence with a variable X-amplitude spin-lock pulse¹ and spinal64 proton decoupling. 1500 transients were acquired using a contact time of 1.0 ms, an acquisition time of 12.5 ms (1024 data points zero filled to 16 K) and a recycle delay of 5 s. All ¹³C NMR spectra were referenced to adamantane (the upfield methine resonance was taken to be at δ=29.5 ppm² on a scale where δ(TMS)=0) as a secondary reference.

Scanning Electron Microscopy (SEM).

SEM images were obtained using a JEOL JSM 6610 scanning microscope.

Brunauer-Emmett-Teller Surface Area Analysis (BET).

The gas adsorption isotherm for nitrogen adsorption onto the LDH surface was measured using a Tristar II plus 3030. The samples were degassed at 110° C. overnight using a VacPrep degas machine. The Brunauer-Emmett-Teller (BET) method was then used to calculate the surface area.

### 1. Relationship Between Metal Salt Precursor Concentration and Product LDH Particle Size

(A) 50 ml of a metal salt precursor solution, wherein the solution was 1.28 M Ca(NO₃)₂.4H₂O and 0.64 M Al(NO₃)₃.9H₂O, was put into a laboratory blender together with 50 ml of 4.4 M NaOH and mixed at 20,000 rpm for 90 s. Ca—Al—NO₃ LDH precipitated during this rapid mixing stage. The liquor containing the precipitated material was centrifuged at 9,000 rpm for 10 minutes followed by washing with deionised water. The centrifugation and washing steps were repeated three times to give a product in the form of a wet paste.
   The preparation procedure was repeated using:
(B) a metal precursor solution of 0.64 M Ca(NO₃)₂.4H₂O and 0.32 M Al(NO₃)₃.4H₂O with 2.2 M NaOH; and
(C) a metal precursor solution of 0.32 M Ca(NO₃)₂.4H₂O and 0.16 M Al(NO₃)₃.9H₂O with 1.1 M NaOH; and
(D) a metal precursor solution of 0.16 M Ca(NO₃)₂.4H₂O and 0.08 M Al(NO₃)₃.9H₂O with 0.55 M NaOH.

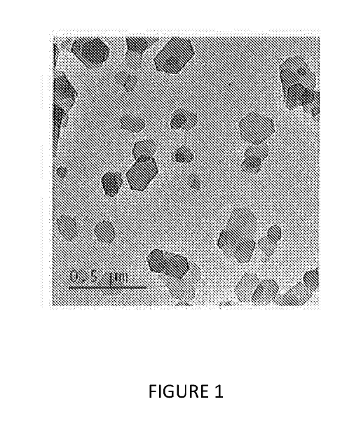

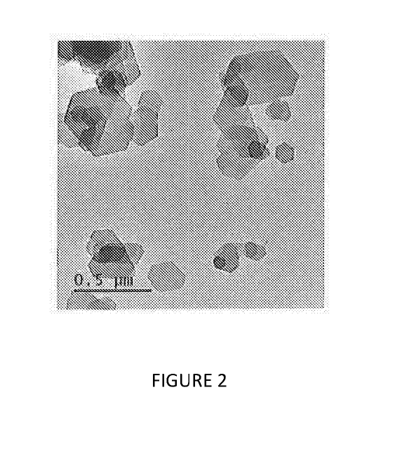

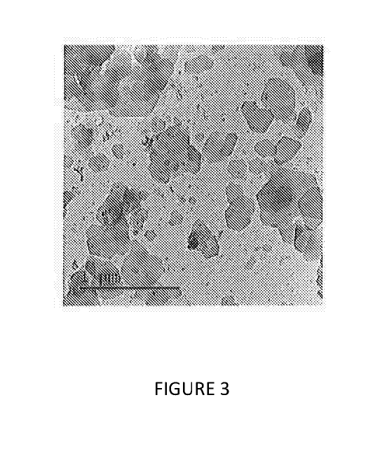

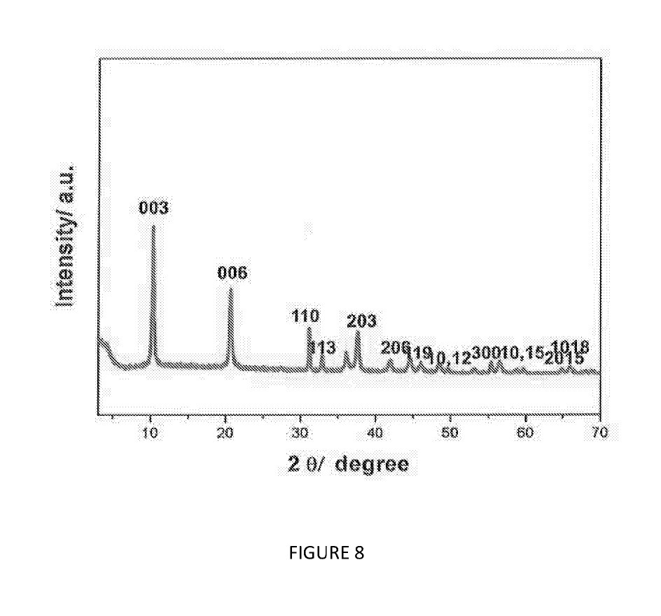

The particle sizes of the Ca—Al—NO₃ LDH's obtained were measured. The results are shown in Table 1. T.E.M. images of the Ca—Al—NO₃ LDH crystals obtained in (B), (C) and (D) are shown in FIGS. 1, 2 and 3, respectively. The Ca—Al—NO₃ LDH obtained in Example B was subjected to X-ray powder diffraction analysis. The plot of intensity (a.u.) against 2 Theta (degree) for the material is shown in FIG. 8.

TABLE 1

| | | | | Stirring time | Particle |
|---|---|---|---|---|---|
| Example | Ca(NO₃)₂•4H₂O/M | Al(NO₃)₃•9H₂O/M | NaOH/M | and speed | size/nm |
| A | 1.28 | 0.64 | 4.4 | 90 s 20000 rpm | 80 |
| B | 0.64 | 0.32 | 2.2 | 90 s 20000 rpm | 100 |
| C | 0.32 | 0.16 | 1.1 | 90 s 20000 rpm | 200-300 |
| D | 0.16 | 0.08 | 0.55 | 90 s 20000 rpm | 300-500 |

It is clear from the results shown in Table 1 that the particle size of the LDH particles obtained depends on the concentration of the metal salts in the metal precursor solution used. The highest metal salt concentration used gave the smallest LDH particles (80 nm) and the lowest metal salt concentration used gave the largest sized LDH particles with a distribution of 300-500 nm.

### 2. Relationship Between Ageing Time and Product LDH Particle Size

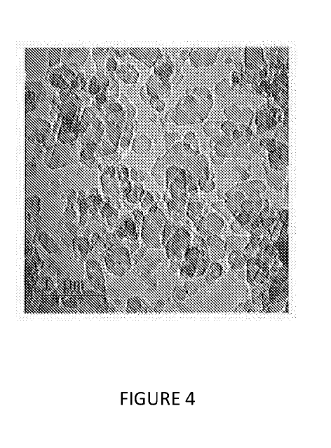

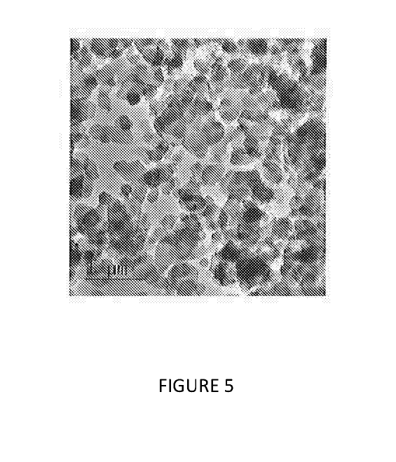

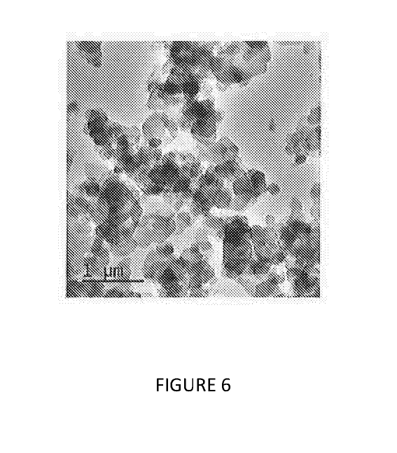

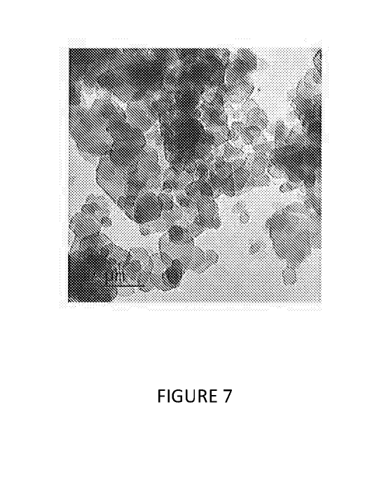

Using solutions according to (D) in Experiment 1 above, the relationship between ageing time and product LDH particle size was investigated. As in Experiment 1 above, the basified solutions were subjected to mixing at 20,000 rpm for 90 s in a laboratory blender. After this 90 s mixing, the solutions were each aged while maintaining the stirring speed of the laboratory mixer at 600 rpm. The ageing times, at this stirring speed, were 2 h (Example E), 4 h (Example F), 6 h (Example G) and 8 h (Example H). The particle size of the LDH products obtained in each case was determined. The results are shown below in Table 2. T.E.M. images of the Ca—Al—NO₃ LDH crystals are shown in FIG. 4 (Example E), FIG. 5 (Example F), FIG. 6 (Example G) and FIG. 7 (Example H).

TABLE 2
Ageing time dependence on particle size control

| | | | | | Ageing time/h & | |
|---|---|---|---|---|---|---|
| | | | | Stirring time/s | stirring speed/rpm + | Particle |
| Example | Ca(NO₃)₂•4H₂O/M | Al(NO₃)₃•9H₂O/M | NaOH/M | and speed/rpm | N₂ | size/nm |
| E | 0.16 | 0.08 | 0.55 | 90 s 20000 rpm | 2 h 600 rpm | 300-500 |
| F | 0.16 | 0.08 | 0.55 | 90 s 20000 rpm | 4 h 600 rpm | 500-700 |
| G | 0.16 | 0.08 | 0.55 | 90 s 20000 rpm | 6 h 600 rpm | 600-800 |
| H | 0.16 | 0.08 | 0.55 | 90 s 20000 rpm | 8 h 600 rpm | 800-1000 |

It can be seen from the results reported in Table 2 that ageing for 8 hr at 600 rpm considerably increases the particle size distribution compared to the particle size range obtained in Example D of Experiment 1 reported above. It can also be seen that particle size of the LDH obtained in this experiment increases with increasing ageing time.

### 3. Preparation of Mg₃Al-LDH—30 g Scale

Carbonate intercalated Mg₃Al-LDH (Mg₃Al(OH)₈(CO₃)_{0.5}.4H₂O, Mg₃Al—CO₃ LDH) has been synthesised using rapid mixing method. 59.97 g of Mg(NO₃)₂.6H₂O and 29.25 g of Al(NO₃)₃.9H₂O are mixed in 100 ml of degassed DI water called solution A. 24.96 g of NaOH and 4.134 g of Na₂CO₃ are dissolved in 150 ml of degassed DI water called solution B. These precursor solutions are mixed rapidly via homogeniser at 20,000 rpm. The LDH has been made at room temperature for 30 minutes. Vacuum filtration and washing with DI water are used to remove excess salts. The LDH is then treated with acetone with the ratio of weight of LDH powder and acetone to 1:10 for 1 hr. The LDH is separated from acetone and left to dry under vacuum oven at 65° C. for 8 hours.

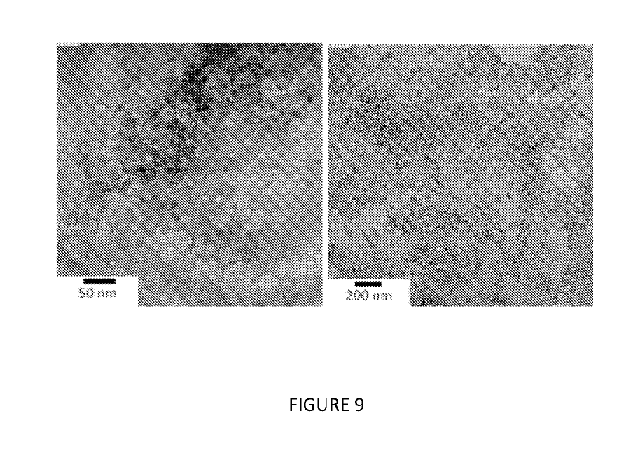

FIG. 9 shows TEM of Mg₃Al(OH)₈(CO₃)_{0.5}.4H₂O powder after acetone treatment and aging for 30 minutes.

### 4. Preparation of Ca₂Al-LDH—30 g Scale

Nitrate intercalated Ca₂Al-LDH (Ca₂Al(OH)₆(NO₃).2H₂O, Ca₂Al—NO₃ LDH) has been synthesised using rapid mixing method. 44.42 g of Ca(NO₃)₂.4H₂O and 35.36 g of Al(NO₃)₃.9H₂O are mixed in 150 ml of degassed DI water called solution A. 22.57 g of NaOH is dissolved in 100 ml of degassed DI water called solution B. These precursor solutions are mixed rapidly via homogeniser at 20,000 rpm. These series of the LDHs has been made at room temperature for aging time of 2, 5, 10, 20, and 30 minutes. Vacuum filtration and washing with DI water are used to remove excess salts. The LDHs are then treated with acetone with the ratio of weight of LDH powder and acetone to 1:10 for 1 hr. The LDHs are separated from acetone and left to dry under vacuum oven at 65° C. for 8 hours.

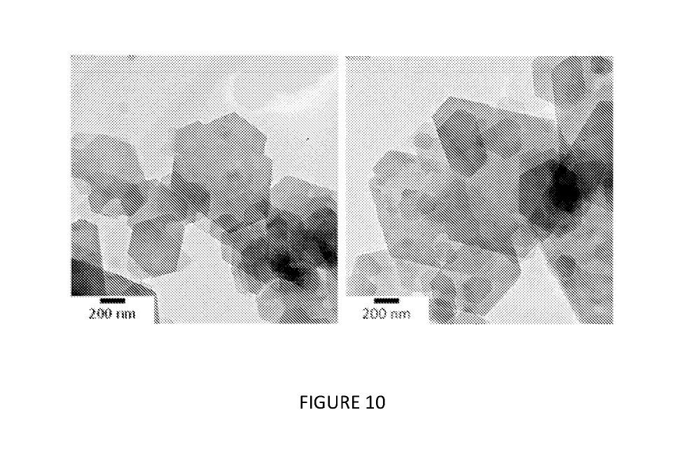

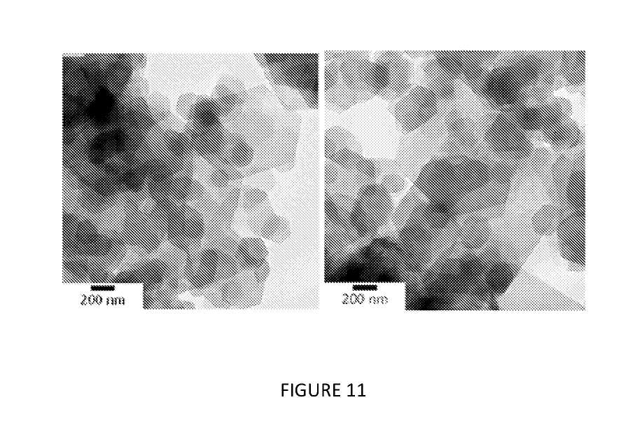

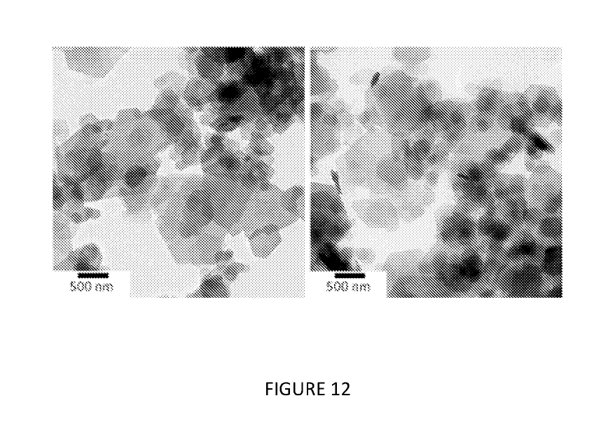

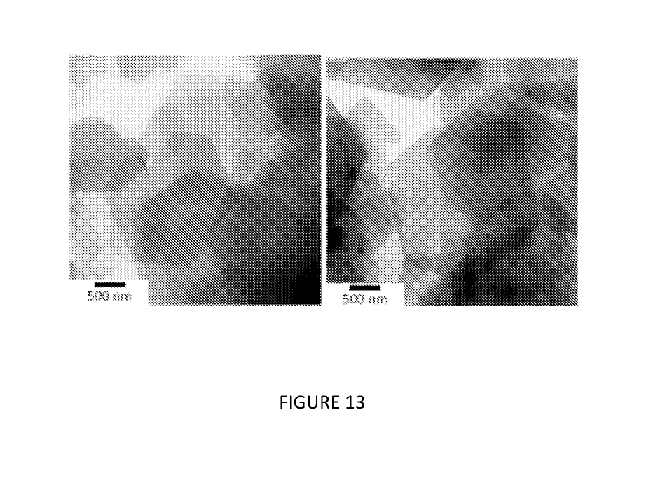

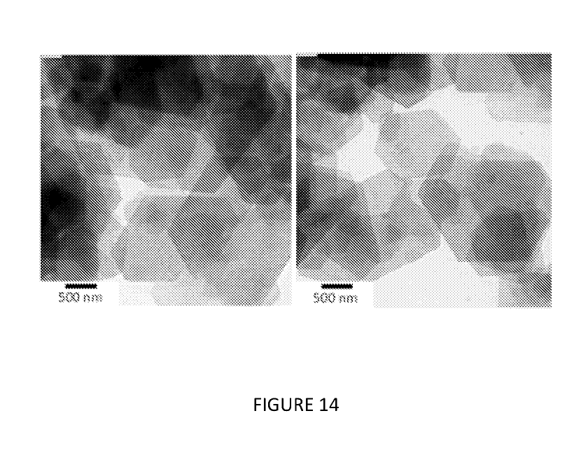

FIGS. 10-14 show TEM of Ca₂Al(OH)₆(NO₃).2H₂O powder after acetone treatment and aging at 2, 5, 10, 20, and 30 minutes respectively.

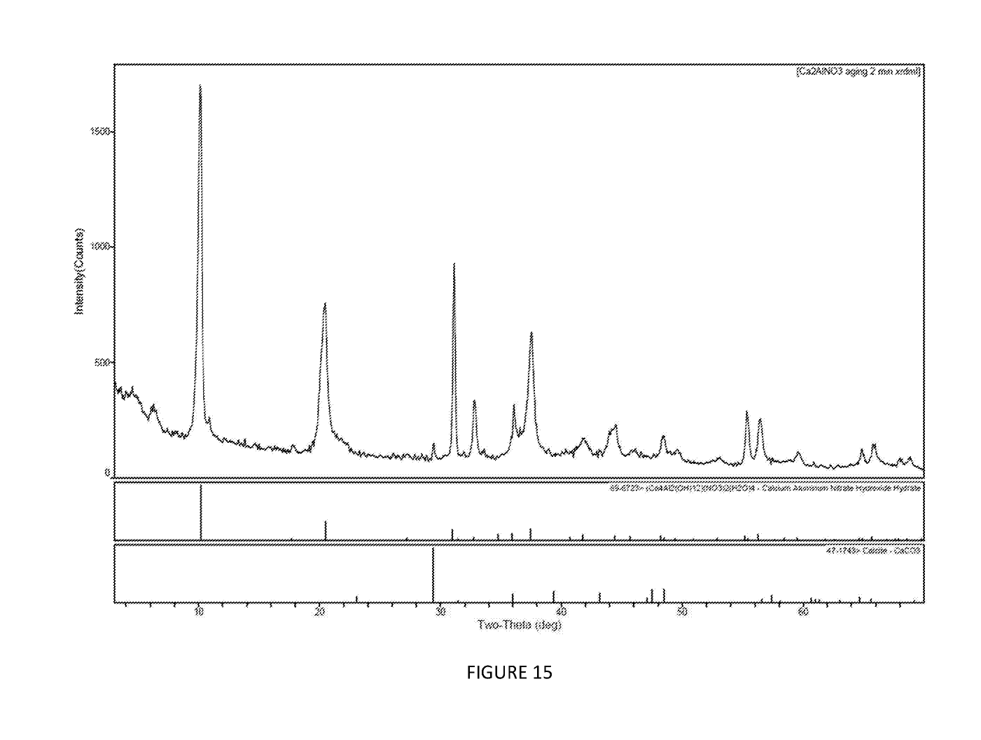

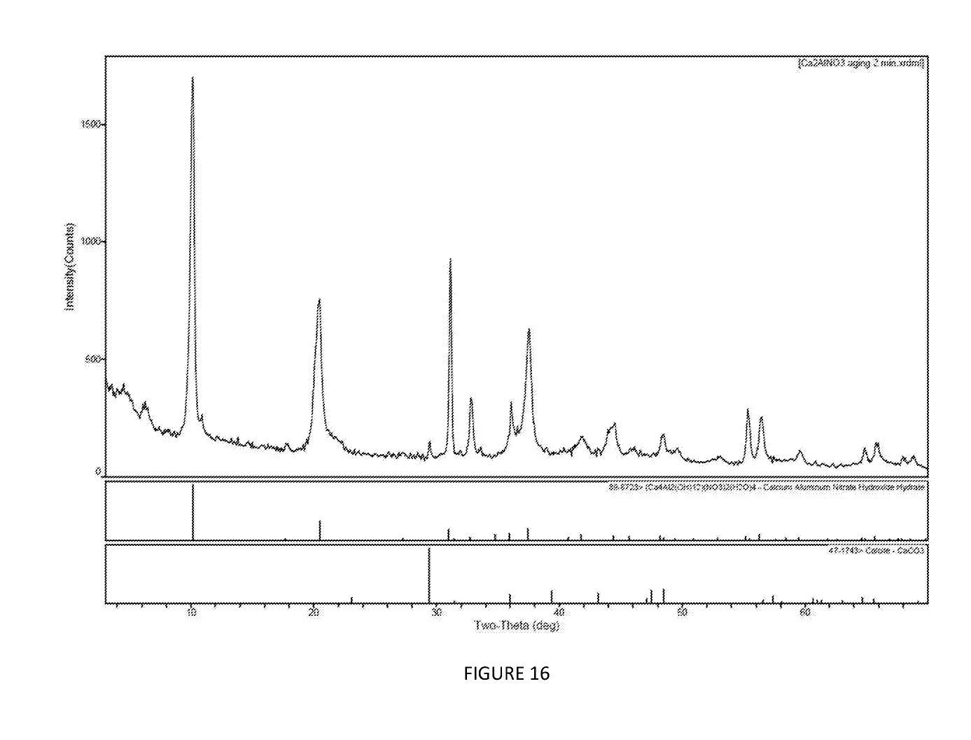

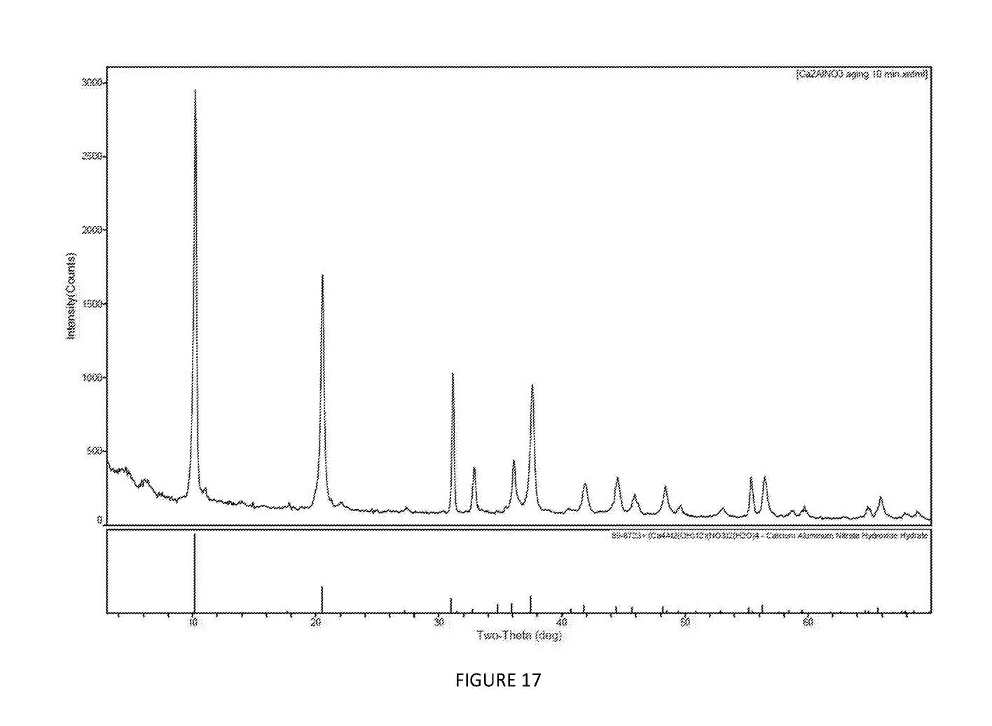

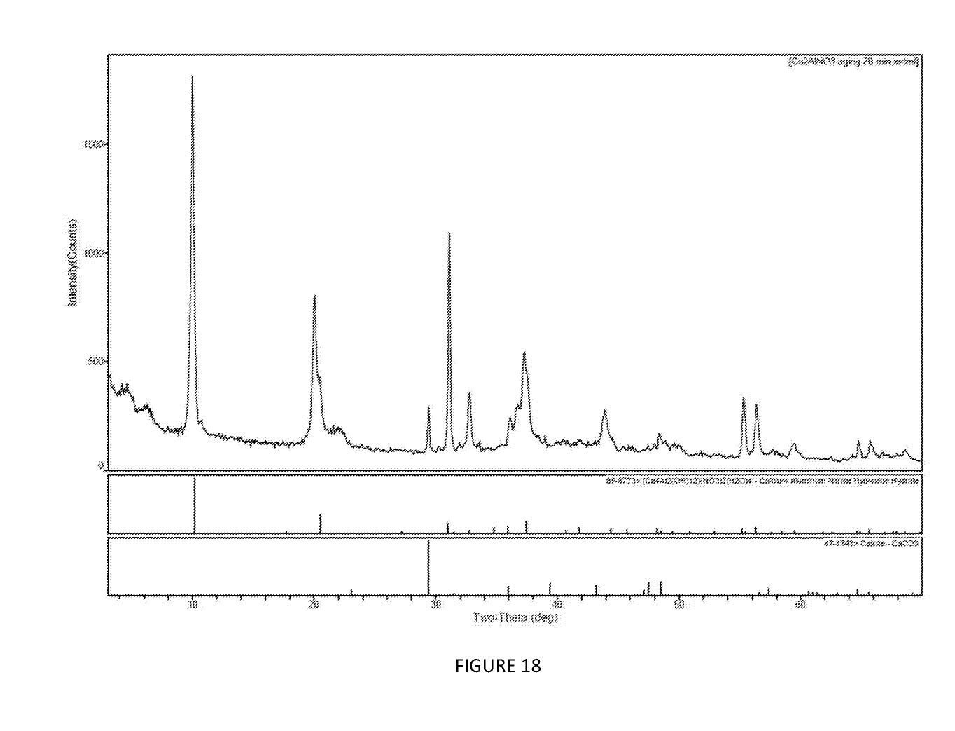

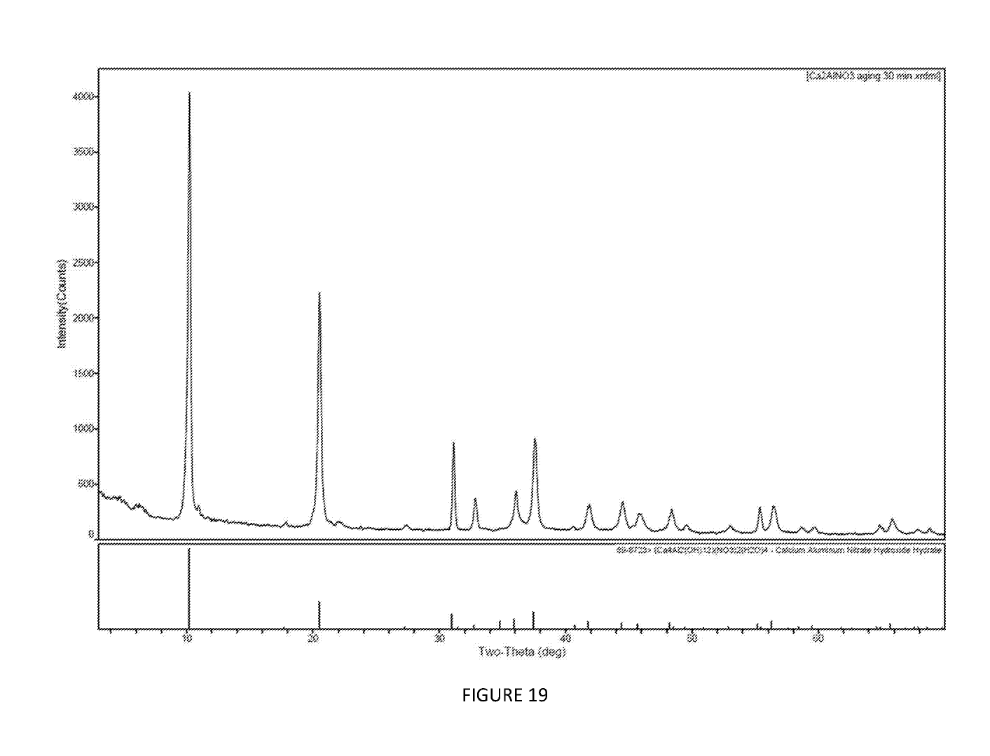

FIGS. 15-19 show XRD patterns of Ca₂Al(OH)₆(NO₃).2H₂O after aging at 2, 5, 10, 20, and 30 minutes respectively.

### 5. Preparation of Ca₂Al-LDH Dispersed in Ethyl Acetate—150 g Scale

Nitrate intercalated Ca₂Al-LDH (Ca₂Al(OH)₆(NO₃).2H₂O, Ca₂Al—NO₃ LDH) has been synthesised using rapid mixing method. 266.52 g of Ca(NO₃)₂.4H₂O and 212.16 g of Al(NO₃)₃.9H₂O are mixed in 900 ml of degassed DI water called solution A. 135.42 g of NaOH is dissolved in 1,100 ml of degassed DI water called solution B. These precursor solutions are mixed rapidly via homogeniser at 20,000 rpm. The LDH has been made at room temperature for aging time of 10, 20, and 30 minutes. Vacuum filtration and washing with 3,600 ml of DI water are used to remove excess salts. The LDH is then treated with acetone with the ratio of weight of LDH powder and acetone to 1:10 for 1 hr. The LDH is separated and dispersed in 1,800 ml of ethyl acetate for 1 hr. And then the LDH is separated and suspended in 1,800 ml of ethyl acetate.

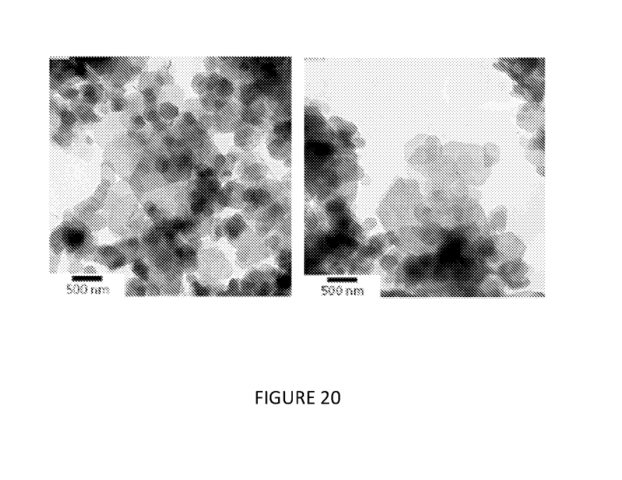

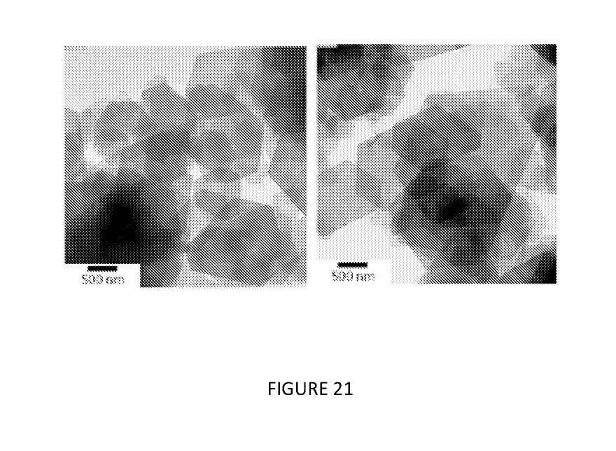

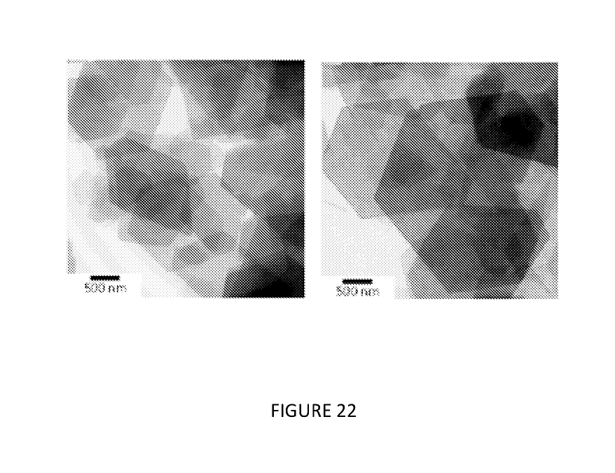

FIGS. 20-22 show TEM of Ca₂Al(OH)₆(NO₃).2H₂O dispersed in ethyl acetate after aging at 10, 20 and 30 minutes respectively.

### 6. Further Aging Studies

Synthesis of Ca₂AlNO₃-LDH 7.56 g of Ca(NO₃)₂ and 6.00 g of Al(NO₃)₃ (to give a 2:1 Ca:Al ratio of cations) were dissolved in 50 mL of deionised and degassed water (purged with N₂ for two hours to remove any carbonate ions), to give a 0.64 M solution of calcium ions and a 0.32 M solution of aluminium ions. 4.40 g of NaOH pellets were dissolved in another 50 mL of deionised and degassed water to give a 2.2 M solution of NaOH. The colloid mill was first washed with water, and then deionised water three times. The previous two solutions were then poured into the mill for a mixing time of 90 s, the rotor speed was set to 2000 rpm and the gap to G5. After mixing the product was collected, and the colloid mill was washed once with water, once with 10% HNO₃ and then twice again with deionised water. The Ca₂AlNO₃-LDH sample was washed using deionised and degassed water 4 times using a centrifuge at 9000 rpm for 5 minutes. The sample was then collected, ˜0.5 g was dried in a vacuum oven for characterisation; the rest of the paste was stored in a fridge at 8° C.

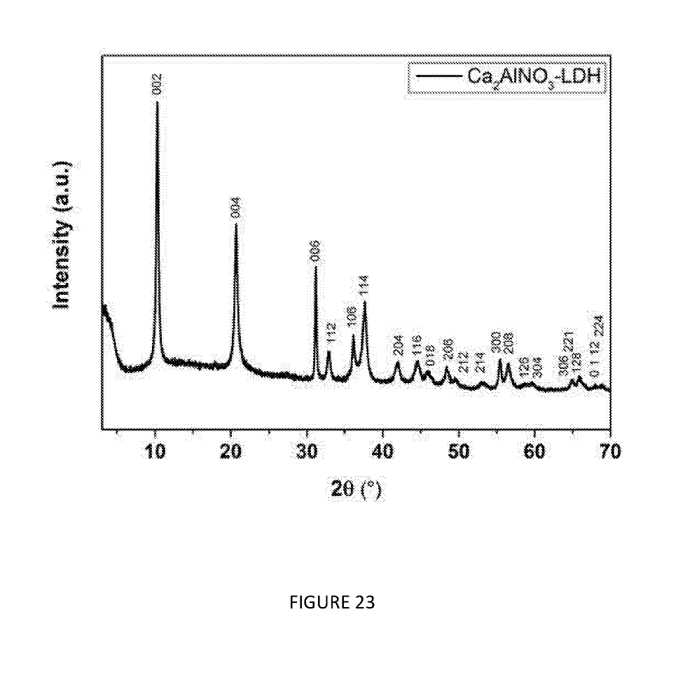

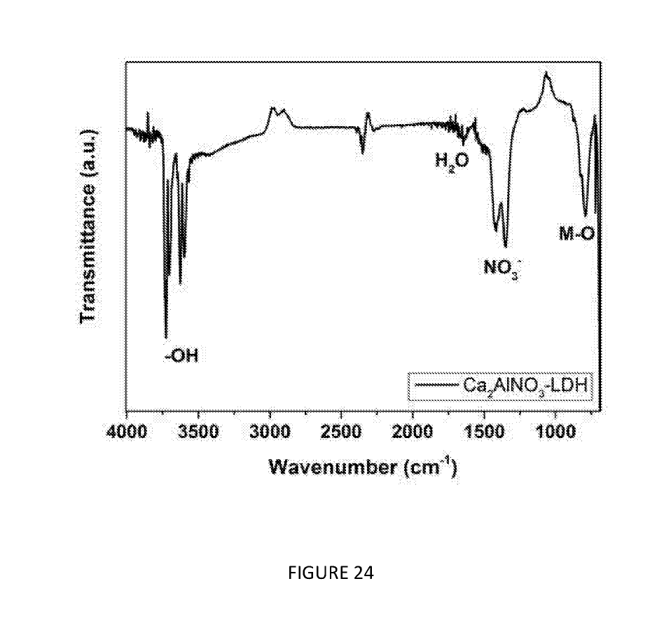

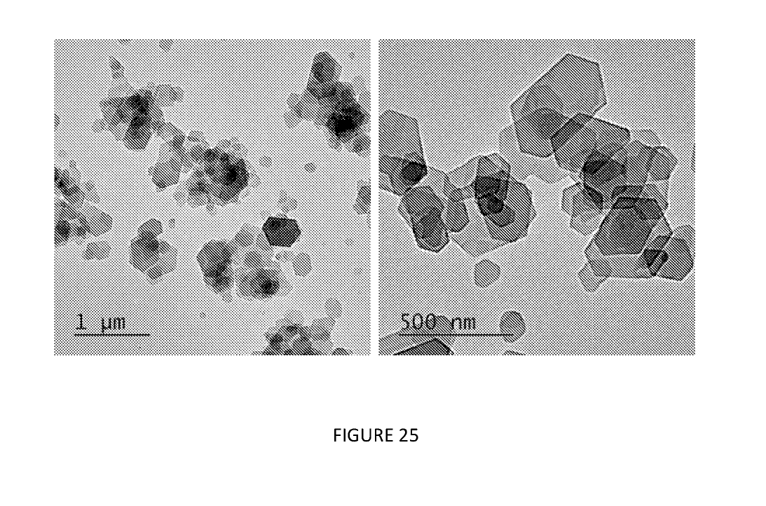

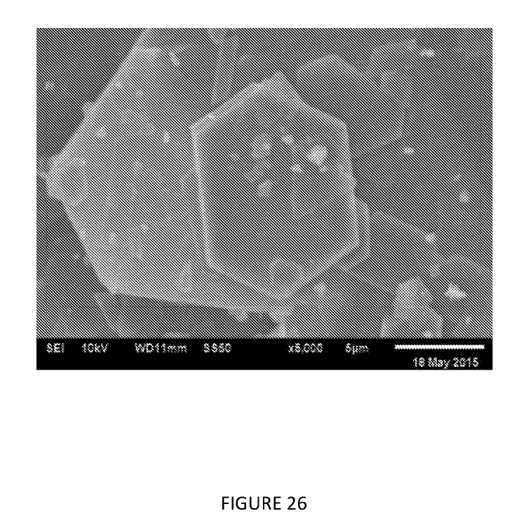

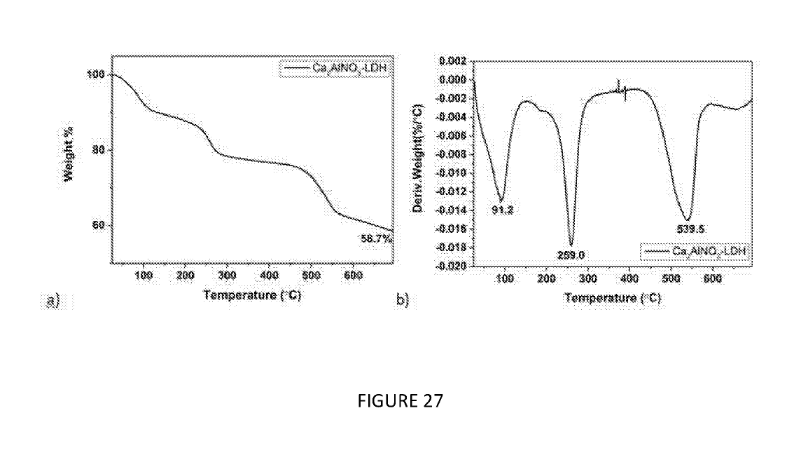

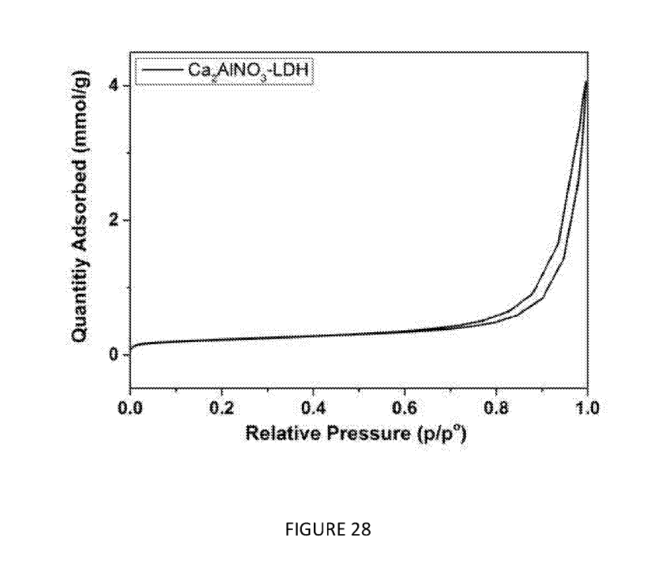

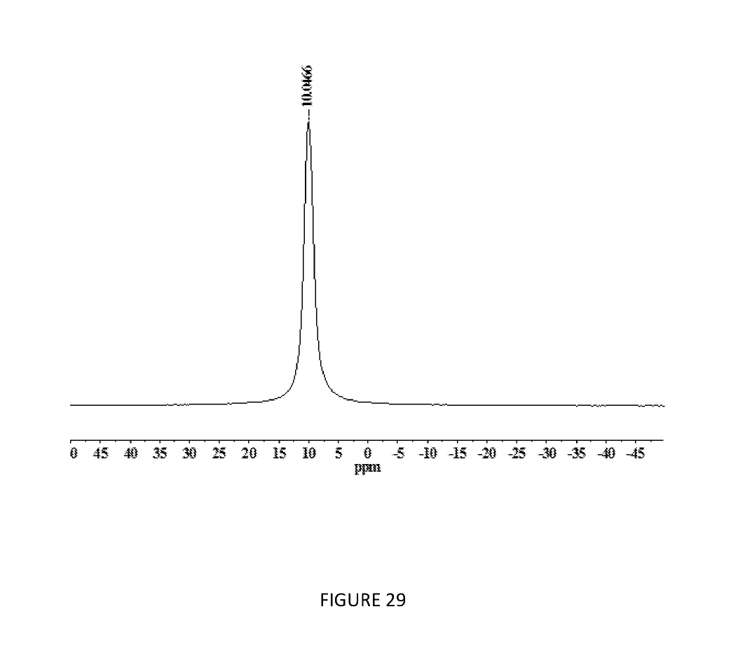

Ca₂AlNO₃-LDH was synthesised using the rapid mixing method in the colloid mill as detailed below. The powder X-ray (XRD) pattern of Ca₂AlNO₃-LDH shown in FIG. 23 is consistent with the expected pattern. The infra-red (IR) spectroscopy is shown in FIG. 24 and highlights absorptions at 3600 cm⁻¹ (—OH and intercalated water), 1630 cm⁻¹ (bending mode of water), 1400 and 1350 cm⁻¹ (N—O stretching mode of the intercalated NO₃⁻). The transmission electronic microscopy (TEM) and scanning electronic microscopy (SEM) images show that the LDH particles synthesised using the rapid mixing method in the colloid mill have a hexagonal plate like morphology as expected from the literature, FIGS. 25 and 26. The darker areas on the TEM image indicate stacking of the LDH sheets, or a thicker sheet, The average particle size was found to be 250 nm, with a large standard deviation of 106 nm. Thermogravimetric analysis (TGA) was used to analyse the thermal decomposition of the Ca₂AlNO₃-LDHs, FIG. 27. The first weight loss between room temperature and 200° C. (T1) is due the loss of the physisorbed water (or other solvent) either on the surface or in the interlayer. The second weight loss which occurs between 200 and 450° C. (T2) is due to the loss of water from dihydroxylation of the inorganic layers. The third beyond 450° C. (T3) is due to the decomposition of the intercalated nitrate group (or other guest anions). The Brunauer-Emmett-Teller (BET) demonstrates a curved shape of the adsorption isotherm suggesting a microporous structure, FIG. 28. The LDH sample has a surface area of 17.95 m².g⁻¹, similar to publish data. The ²⁷Al solid state NMR spectrum shows one resonance peak at 10.05 ppm, consistent with a single aluminium environment in the sample, FIG. 29.

### Effect of Aging Time

The Ca₂AlNO₃-LDH paste sample was left in a fridge at 8° C. Small amounts of the sample were extracted and tested after 1 week, and after 4 weeks.

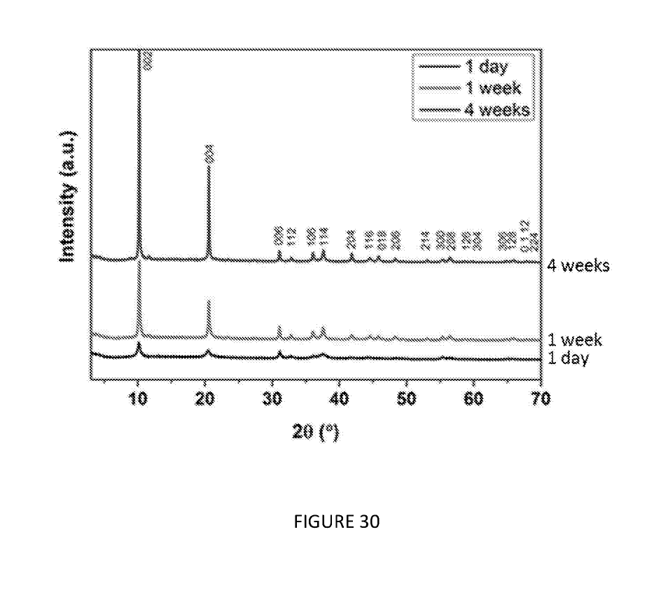

Paste Ca₂AlNO₃-LDH samples synthesised by rapid mixing method were stored at 8° C. and tested after different time periods to observe the effect on the particles. The sharpness of the diffraction peaks increases as the ageing time is increased, the 002 peak increased in intensity from 931 to 11871 a.u. in 4 weeks, showing there is a significant change in the particles over time despite the low temperatures (FIG. 30 and Table 3).

TABLE 3
Peak intensities and CDLs of Ca₂AlNO₃-
LDHs after different lengths of time at 8° C.

| | | CDL along c-axis | CDL along a- and b- |
|---|---|---|---|
| | Intensity of 002 | using 002 | axes, using 300 |
| | reflections | reflections | reflections |
| Time at 8° C. | (a.u.) | (Å) | (Å) |
| 1 day | 931.0 | 146.6 | 106.7 |
| 1 week | 4245.3 | 448.0 | 177.8 |
| 4 weeks | 11871.0 | 733.2 | 251.9 |

An average crystallite size (or the mean crystallite domain length (CDL) along the a-, b- and c-axes) can be calculated using the Scherrer equation. The CDL along the c-axis increased from 143.4 to 717.0 Å in 4 weeks, Table 3. This is an important discovery for the future storage of Ca₂AlNO₃-LDHs as wet pastes for their use as additives in cement technology where particle size is important.

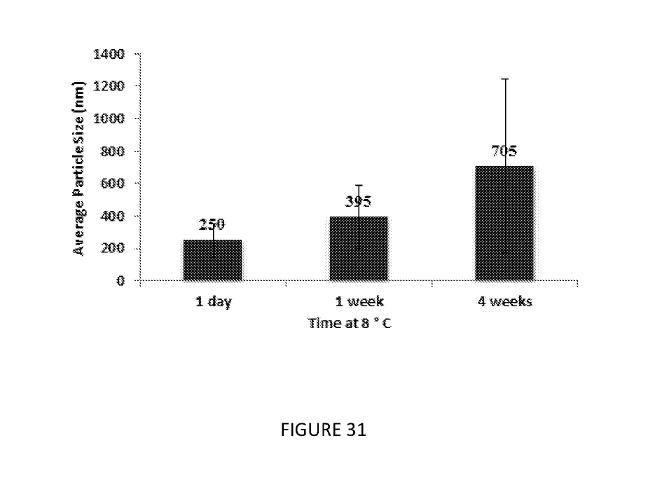

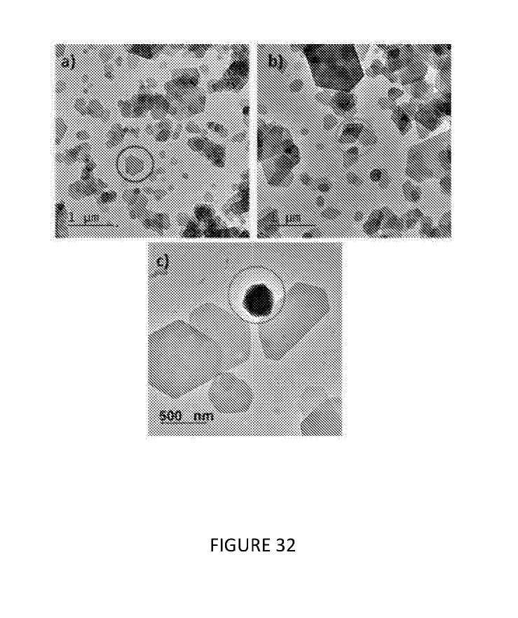

The average particle sizes calculated from the TEM images reveals a large increase in average particle size when the LDHs are left at 8° C., from 250 to 705 nm in 4 weeks, confirming previously analysed data. However, the standard deviation for the data is extremely large (FIG. 31). However, more importantly, the morphology begins to change (FIG. 32). Immediately after synthesis most of the LDH particles have a hexagonal plate-like morphology (circled in FIG. 32a). As ageing time is increased the particles begin to stretch in one plane forming parallelogram shaped plate-like LDH particles (circled in FIG. 32b). This may be because the surface energy of one face is lower than another, so the particles grow preferentially in one direction. The TEM images of the LDHs that have been left in the fridge for 4 weeks show 3D diamond like LDH particles (circled in FIG. 32c).

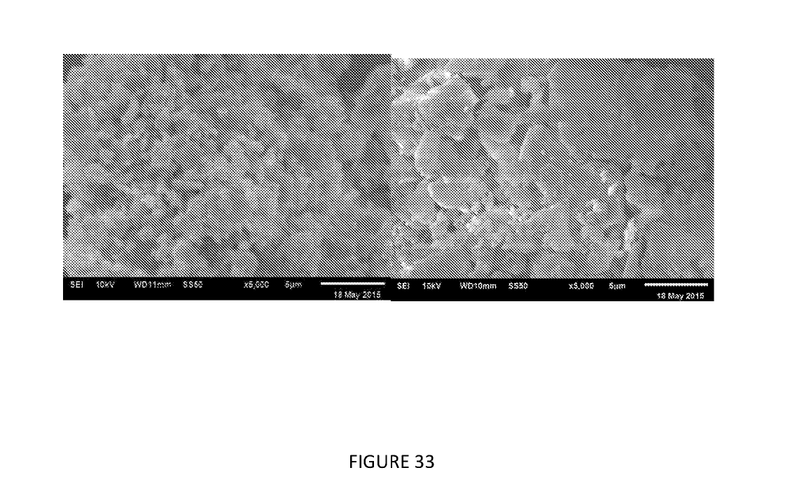

Scanning electron microscopy (SEM) was also be used to study the particles morphology. The morphology directly after synthesis had well defined hexagonal plate-like Ca₂AlNO₃-LDH particles, FIG. 26. The morphology of the particles after ageing appears significantly less defined, FIG. 33.

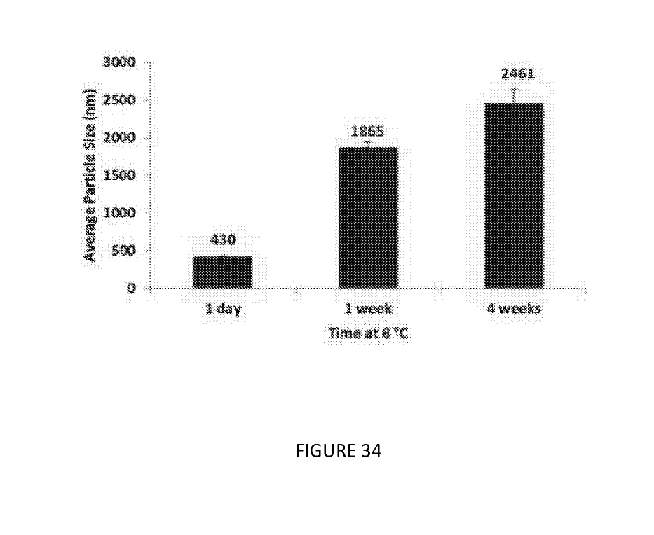

The DLS data in FIG. 34 shows a very significant increase in particle size with ageing time. The average particle size increased from 430 to 1865 and 2461 nm in 1 and 4 weeks respectively, the standard deviation of the average particle size also increased from 8 to 188 nm. TGA data also reveal an increase in particle size with ageing time. Table 4 shows that the temperatures of weight loss are much higher after ageing in the fridge. This is due to the increased particle size.

TABLE 4
TGA data after different ageing times at 8° C.

| | Temperature (° C.) | | |
|---|---|---|---|
| Ageing Time | T1 | T2 | T3 |
| 1 day fridge | 90.3 | 258.0 | 539.5 |
| 1 week fridge | 105.5 | 273.3 | 565.4 |
| 4 weeks fridge | 100.2 | 275.4 | 576.7 |

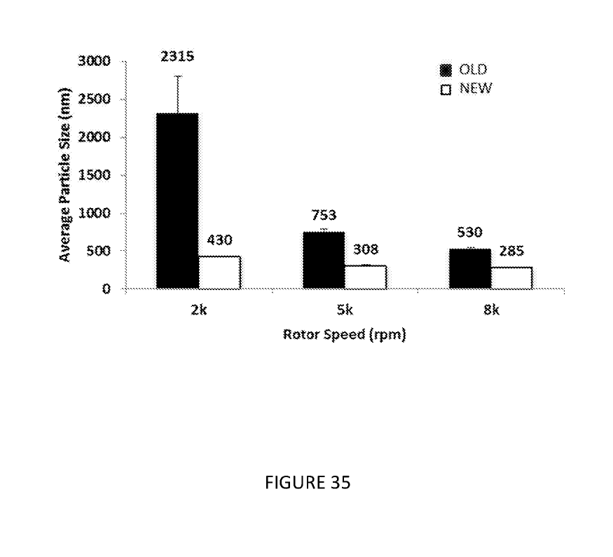

It is possible to see a strong effect due to the speed of colloid mill, FIG. 35. There is a strong effect on the particle size when the samples were aged at 8° C. from 2315 to 753 and 530 nm for 2000, 5000 and 8000 rpm speed of the rotor respectively, FIG. 35. The effect is not as noticeable on fresh samples.

### Effect of Aging Temperature

Three different Ca₂AlNO₃-LDH paste samples were left for 1 week at different temperatures. One was left at room temperature, 23° C., one in a fridge, 8° C., and one at −20° C. in a freezer. The samples were tested after this week.

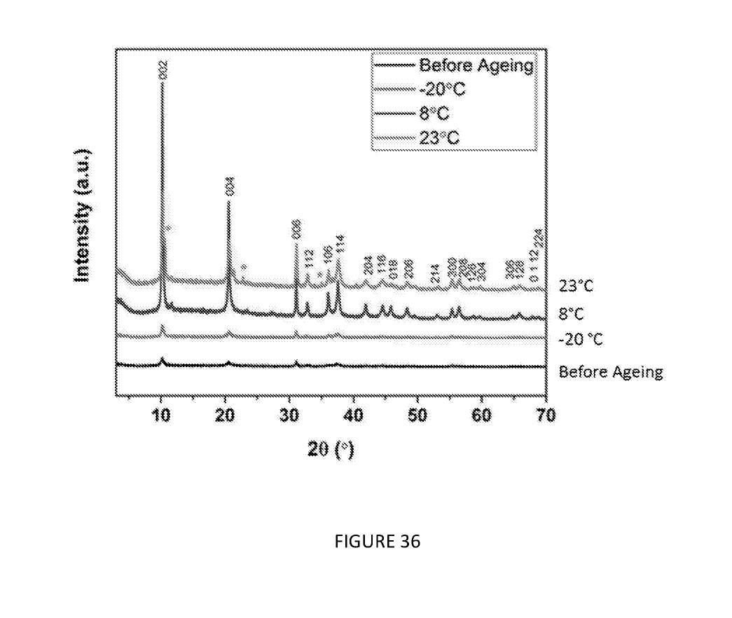

To investigate how temperature affects the rate of growth and change in morphology of the LDH particles paste samples of Ca₂AlNO₃-LDH synthesised by rapid mixing method were left for 1 week at different temperatures and then tested. The XRD patterns show a sharpening of the peaks after ageing at 8 and 23° C., consistent with an increase in crystallinity (FIG. 36). Use of the Scherrer equation suggests that the particles have grown after 1 week at all temperatures, even at −20° C. (Table 5). The CDL along the c-axis has increased from 143.4, to 183.4, 483.2 and 303.4 Å for −20, 8 and 23° C. respectively.

TABLE 5
Peak intensities and CDLs of Ca₂AlNO₃-LDHs after
1 week ageing at different temperatures.

| | | CDL along c-axis | CDL along a- and b- |
|---|---|---|---|
| 1 Week Ageing | Intensity of 002 | using 002 | axes, using 300 |
| Temperature | reflections | reflections | reflections |
| (° C.) | (a.u.) | (Å) | (Å) |
| Before Ageing | 931.0 | 146.6 | 106.7 |
| −20 | 221.2 | 187.6 | 177.9 |
| 8 | 4245.3 | 448.0 | 177.9 |
| 23 | 1725.5 | 310.2 | 177.9 |

The particles appear to grow less at room temperature (23° C.) than in the fridge (8° C.), which were a surprising result. However, the XRD pattern for Ca₂AlNO₃-LDH paste after 1 week ageing at 23° C. appears to be impure as extra diffraction peaks are seen. This indicates that the Ca₂AlNO₃-LDHs paste synthesised by rapid mixing method are not stable at room temperature and therefore have started to decompose during the week, having a direct effect on particle growth. This explains why the Ca₂AlNO₃-LDH aged at 8° C. is more crystalline than at 23° C. (002 peaks have intensities of 4245.3 and 1725.5 a.u.). The impurities appear to be calcium aluminium oxide carbonate hydrate, and calcium aluminium oxide nitrate hydroxide carbonate.

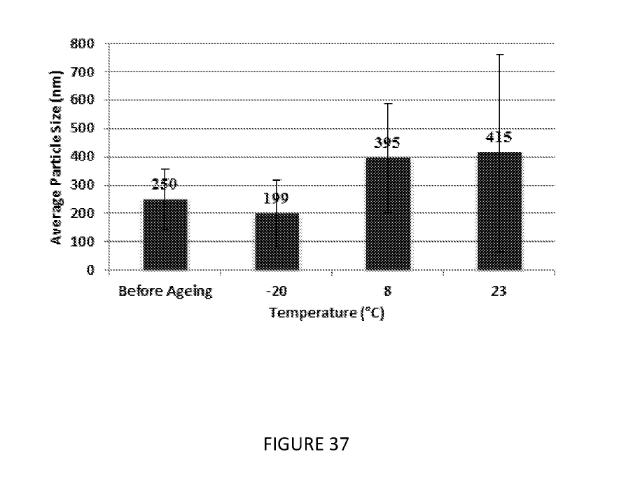

Particle size was also studied using the TEM images. These data suggest an increase in particle size with ageing temperature, FIG. 37. Particles stored at −20° C. for 1 week had an average particle size of 199 nm, and particles stored at 23° C. had an average size of 415 nm. The standard deviation in particle size increased as storage temperature increased demonstrating a loss of control on the average particle size.

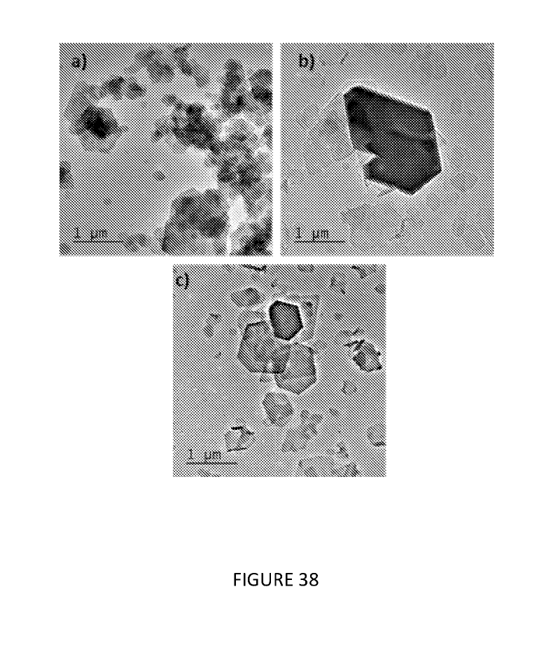

TEM images were also used to study the particle morphology (FIG. 38a/b stored at −20° C. for 1 week; FIG. 38c stored at 23° C. for 1 week). The particles stored at −20° C. seemed uniform. The particles stored at 8° C. are well defined but have a larger variation of particle sizes (FIG. 32), the particles stored at 23° C. appear less well defined and exhibit impurities (FIG. 38), as the XRD data also suggested.

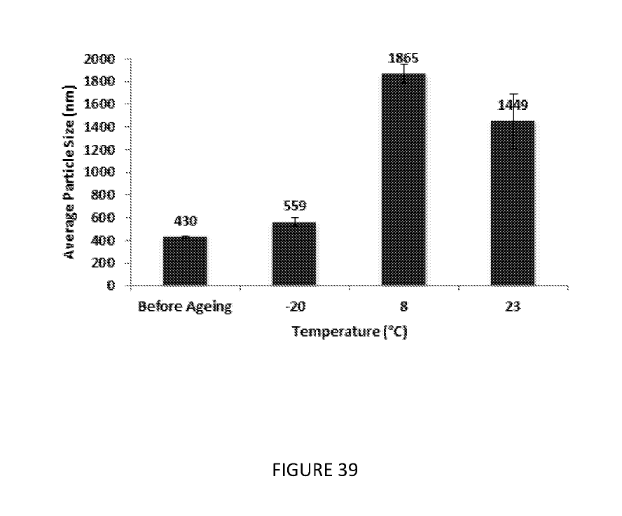

DLS was also used to study the particles size. When the sample was left at −20° C. for a week the average particle size increased to 559 nm (FIG. 39). This shows that ageing is significantly slowed, or perhaps stopped, when Ca₂AlNO₃-LDH is stored at very low temperatures. The Ca₂AlNO₃-LDH particles left at room temperature (23° C.) appear to be smaller (1449 nm) than the sample left at 8° C. (1865 nm, see FIG. 39), certainly due to the presence of the decompositions products.

The TGA data further suggest that the particles have increased in size after ageing at all temperatures as the weight loss temperatures have increased (Table 6).

TABLE S4
TGA data for Ca₂AlNO₃-LDHs after one week
ageing at different temperatures.

| Ageing | | | |
|---|---|---|---|
| Temperature | Temperature (° C.) | | |
| (° C.) | T1 | T2 | T3 |
| Before Ageing | 90.3 | 258.0 | 539.5 |
| −20 | 111.8 | 271.7 | 551.0 |
| 8 | 102.2 | 272.7 | 568.3 |
| 23 | 115.4, 149.3 | 275.2 | 565.8 |

The features disclosed in the foregoing description, in the claims and in the accompanying drawings may, both separately and in any combination thereof, be material for realizing the invention in diverse forms thereof.

1. A process for preparing particles of a layered double hydroxide of the general formula
[Mₚ^{z+}M′_{q}^{y+}(OH)₂]^{a+}(Xⁿ⁻)_{a/n}.bH₂O (I)
wherein
M^{z+} and M′^{y+} are metal cations or mixtures of metal cations;
z=1 or 2;
y=3 or 4;
p+q=1;
b=0 to 10;
Xⁿ⁻ is an anion, wherein n is 1 to 5; and
a is determined by p, q, y and z such that a=zp+yq−2;
which process comprises
(a) mixing M^{z+} cations, M′^{y+} cations and Xⁿ⁻ anions, with a base; and
(b) allowing the layered double hydroxide of formula to precipitate from the solution mixed in step (a);
wherein step (a) is performed in aqueous solution, and under an atmosphere of air, for a period not longer than 15 minutes; and
wherein the mixing speed and duration of step (a) are such that the layered double hydroxide that precipitates in step (b) has a particle size of not greater than 2000 nm.

2. The process according to claim 1, wherein the mixing speed and duration of step (a) are such that the layered double hydroxide that precipitates in step (b) has a particle size of not greater than 500 nm.

3. The process according to claim 1, wherein the mixing speed and duration of step (a) are such that the layered double hydroxide that precipitates in step (b) has a particle size of not greater than 300 nm.

4. The process according to claim 1, wherein, in the layered double hydroxide, M/M′ is selected from Mg/Al, and Ca/Al.

5. The process according to claim 1, wherein, in the layered double hydroxide, M/M′ is Ca/Al.

6. The process according to claim 1, wherein Xⁿ⁻ is an anion selected from halide, inorganic oxyanion, anionic surfactants, anionic chromophores, and anionic UV absorbers.

7. The process according to claim 6, wherein the inorganic oxyanion is selected from carbonate, bicarbonate, hydrogenphosphate, dihydrogenphosphate, nitrite, borate, nitrate, sulphate, sulphite, phosphate, and a mixture of two or more thereof.

8. The process according to claim 6, wherein the inorganic oxyanion is nitrate.

9. The process according to claim 1, wherein step (a) is conducted at a speed not slower than 5000 rpm.

10. The process according to claim 1, wherein step (a) is conducted at a speed not slower than 8000 rpm.

11. The process according to claim 1, wherein step (a) is conducted at a speed not slower than 12,000 rpm.

12. The process according to claim 1, wherein step (a) is conducted at a speed not slower than 17,000 rpm.

13. The process according to claim 1, wherein step (a) is carried out for a period of from 1 to 15 minutes.

14. The process according to claim 1, wherein the base is a compound comprising OH⁻ anions.

15. The process according to claim 14, wherein the base is NaOH.

16. The process according to claim 1, wherein the pH of the aqueous solution obtained by the mixing step (a) is greater than 7.

17. The process according to claim 16, wherein the pH value of the aqueous solution of step (a) is adjusted by the addition of NaOH or a mixture of NaOH and NaX, where X⁻ is an anion, to the solution.

18. The process according to claim 1, wherein the process further comprises a step c) of recovering the precipitated layered double hydroxide.

19. Particles of a layered double hydroxide of the general formula
[Mₚ^{z+}M′_{q}^{y+}(OH)₂]^{a+}(Xⁿ⁻)_{a/n}.bH₂O (I)
wherein
M^{z+} and M′^{y+} are metal cations or mixtures of metal cations
z=1 or 2;
y=3 or 4;
p+q=1;
b=0 to 10;
Xⁿ⁻ is an anion, wherein n is 1 to 5; and
a is determined by p, q, y and z such that a=zp+yq−2;
wherein the particles are obtainable, obtained or directly obtained by a process comprising
(a) mixing M^{z+} cations, M′^{y+} cations and Xⁿ⁻ anions, with a base; and
(b) allowing the layered double hydroxide of formula (I) to precipitate from the solution mixed in step (a);
wherein step (a) is performed in aqueous solution, and under an atmosphere of air, for a period not longer than 15 minutes; and
wherein the mixing speed and duration of step (a) are such that the layered double hydroxide that precipitates in step (b) has a particle size of not greater than 2000 nm.

20. A Ca—Al—NO₃ layered double hydroxide, in a substantially pure form, and having a particle size of not greater than 2000 nm.

21. The Ca—Al—NO₃ layered double hydroxide according to claim 20, wherein the layered double hydroxide contains no calcium carbonate.

22. The Ca—Al—NO₃ layered double hydroxide according to claim 21, wherein the layered double hydroxide contains no metal carbonates, or calcium aluminium oxide carbonate hydrate.

23. The Ca—Al—NO₃ layered double hydroxide according to claim 21, having a particle size of not greater than 300 nm.

24. The Ca—Al—NO₃ layered double hydroxide according to claim 20, having a particle size of not greater than 100 nm.

25. The Ca—Al—NO₃ layered double hydroxide according to claim 20, wherein individual crystals of the layered double hydroxide have substantially hexagonal morphology.
